(19) United States
(12) Patent Application Publication
(10) Pub. No.: US 2010/0042974 A1
(43) Pub. Date: Feb. 18, 2010

(54) BUILD OPTIMIZATION WITH APPLIED STATIC ANALYSIS

(75) Inventors: Steve Gutz, Gloucester (CA); Tom MacDougall, Kanata (CA); Mohammed Mostafa, Kanata (CA)

Correspondence Address: IBM - SPP;SHIMOKAJI & ASSOCIATES, P.C., 8911 Research Drive, Irvine, CA, 92618, US

(73) Assignee: INTERNATIONAL BUSINESS MACHINES CORPORATION, Armonk, NY (US)

(21) Appl. No.: 12/190,485

(22) Filed: Aug. 12, 2008

(51) Int. Cl. G06F 9/44

(52) U.S. Cl. 717/121

(57) ABSTRACT

A method of constructing a software build using a static structural analysis system is disclosed. A software build configuration may be run and analyzed by a software analyzer to detect dependencies among code classes and components. A code dependency map is constructed identifying code level dependencies. The code dependency map may be referenced for code classes and components selected for modification. Identified dependency relationships with the selected code classes and components enable a builder to rebuild those code classes and components affected by the modification. Additionally, the software analyzer may identify undesirable dependencies and anti-patterns in potential need of deletion or modification.

### BACKGROUND OF THE INVENTION

The present invention is related to the field of software development and, more particularly, to a method and system of optimizing software builds by using static analysis.

Performing software builds can quickly become a cumbersome problem as the number and size of build components increases. An exemplary software build may include hundreds of components with each component comprising several code classes of line code. Within the overall software build, some of the code classes may depend on one another so that a modification in one code class affects those other code classes that depend from it.

These dependencies can take many forms which may be detrimental to the operation of a software build if the dependencies are not managed correctly. These dependencies may be referred to as anti-patterns when an undesirable feature of one code class leads to a chain reaction effect of problems in other dependent code classes. In some cases, these dependencies can take the form of hubs where many dependencies exist from one code class. Other exemplary cases may involve tangles where circular dependencies may cause a loop of code deficiencies.

It is known in the prior art that the build manager may define and maintain explicit component dependencies. When one manually modifies line code within a software build, one may have to rely on the build manager to show one dependency at a time. A builder may sometimes have little understanding of what the actual language syntax between code dependencies can mean. Therefore, to err on the side of caution, a builder modifying one portion of the software build file may rebuild the entire system. This may create an opportunity for component synchronization problems to arise since classes may be re-factored causing dependency changes. Classes may also end up being moved between components forcing the build manager to re-evaluate the development architecture and react to changes in near real-time. One result may be the construction of unnecessary components. Another result may be the redundant rebuild of all components consuming unnecessary cycle to process the builds.

Hence, there is a need for a method and system of analyzing code class dependencies in a software build and referencing the analysis for rebuilding a software build.

### SUMMARY OF THE INVENTION

A method of constructing a software build comprises: creating a plurality of build components for the software build, each component including at least one code class; running a build manager for the construction of the software build; enabling a software analyzer for analyzing line code in the software build; identifying code dependencies from the line code among two or more code classes between two or more build components; assembling a code dependency map of the identified code dependencies; referring to the code dependency map to detect circular reference anti-patterns in the software build; querying the code dependency map for code classes dependent on a selected code class; evaluating an effect on dependent code classes when the selected code class is modified; and building software code in the software build according to the results of detected circular reference anti-patterns and evaluated effects.

### BRIEF DESCRIPTION OF THE FIGURES

FIG. 1 illustrates a system for a software build construction in accordance with the principles of the invention;

FIG. 2 illustrates a dependency mapping system employed in the software build construction system of FIG. 1; and

FIG. 3 illustrates a flow chart of an exemplary method in accordance with the principles of the invention.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

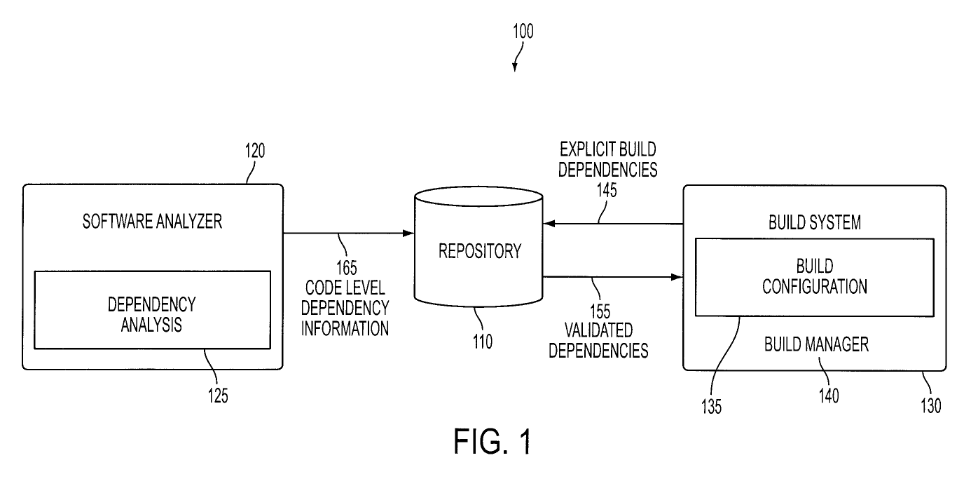

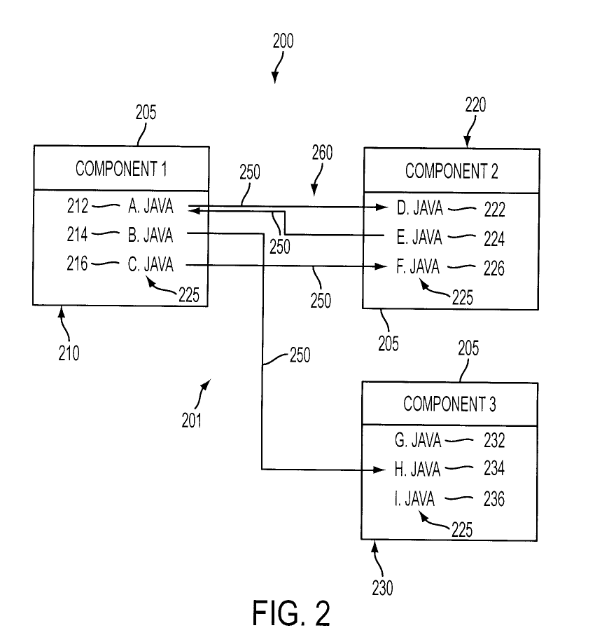

With reference to FIGS. 1 and 2, an exemplary embodiment of the present invention is described. FIG. 1 depicts a system 100 according to the present invention. The system 100 may include a build system 130, a software analyzer 120, and a repository 110 in communication with one another. The build system 130 may incorporate a main software line code 105 and a build configuration 135 for defining the parameters of the build system. The build system 130 may be established by running a build manager 140 for assembling components 205 and code classes 225 of the main software line code 105 into a baseline build configuration 135. A repository 110 may store definition files 115 for components 205 and code classes 225 that may be used in the construction of the build system 130. The software analyzer 120 may incorporate a dependency analysis 125 function that may analyze code level dependencies 250 among code classes 205 in the definition files 115 stored in the repository 110 or directly in the build configuration 135.

Thus, from a top level perspective, when a build configuration 135 may be modified, explicit build dependencies 145 may be identified by the build system 130 and transmitted to the repository 110. The software analyzer 120 may activate the dependency analysis 125 function to scan and evaluate the components 205 and their code classes 225 for code level dependencies 250 among different components 205 and may transmit code level dependency information 165 back to the repository 110. The repository 110 may then forward validated dependencies 155 back to the build system 130. In effect, the build configuration 135 may then focus modifying and rebuilding line code among components 205 with the validated dependencies 155.

With reference to FIG. 2, an exemplary static structural analysis system 200 illustrates code level dependencies using a code dependency map 201. A build configuration 135 (as shown in FIG. 1) may include three components: Component 1 (210); Component 2 (220); and Component 3 (230). Unlike the prior art, which in some cases, may not track relationships among components 205, the dependency mapping system 200 may identify and record, i.e. map, code level dependencies 250 among the components 205. For example, Component 1 (210) may include code classes: A.java 212; B.java 214; and C.java 216. Similarly, Component 2 (220) may include code classes: D.java 222; E.java 224; and F.java 226. Likewise, Component 3 (230) may include code classes: G.java 232; H.java 234; and I.java 236. In this illustrative embodiment of the static structural analysis system 200, a code level dependency 250 exists between A.java 212 of Component 1 (210) and D.java 222 of Component 2 (220) where modifications to the line code in A.java 212 affect the operation of D.java 222. Another code level dependency 250 exists among Component 1 (210) and Component 2 (220) between E.java 224 and A.java 212 where changes in E.java 226 have a consequence on the operation of A.java 212. A code level dependency 250 also exists between Component 1 (210) and Component 2 (220) where H.java 234 depends on B.java 214 and changes to the line code of B.java 214 have a one-way effect on the operation of H.java 234. Yet another code level dependency 250 can be seen between Component 1 (210) and Component 2 (220) where F.java 226 depends from C.java 216 and thus, modifications to C.java 216 have unidirectional results to actions in F.java 236.

Thus, in operation, a system 100 employing the static structural analysis system 200 may allow one to manage and modify a build system 130 by focusing on targeted components 205 by mapping code level dependencies among code classes 225. For example, in a build configuration 135 of n number of components 205, a modification in B.java 214 of Component 1 (210) may be mapped to identify the dependency 250 in H.java 234 of Component 3 (230). Thus, instead of rebuilding the entire build system 130, one may reference the code dependency map 201 and identify that a change in Component 1 (210) will effect a change in Component 2 (230) and more specifically, allow one to adjust B.java 214 and H.java 234 accordingly.

Additionally, one may also appreciate that the static structural analysis system 200 using a code dependency map 201 allows a builder to spot undesirable dependencies 250. For example, as shown, E.java 224 may be setup with a dependency 250 dependent on A.java 212, which, in turn may hold a dependency 250 with D.java 222. In the scenario illustrated in FIG. 2, Component 1 (210) and Component 2 (220), by virtue of such dependencies 250 form a circular dependency 260 between each other. The static structural analysis system 200 may therefore, help identify such exemplary anti-pattern relationships in the dependency analysis function 125 of the software analyzer 120 and alert a builder to their existence permitting the builder to restructure the code classes 212, 222, and 224 of a build configuration 135 to avoid a circular dependency 260 in the build system 130 as shown.

It will be understood that other undesirable dependencies 250 may also be identified such as hubs and tangles. Dependencies 250 created by hubs, for example, may be identified so that a builder may track the numerous other components 205 that depend from a centralized code class 225 and may require modification. Identification of a hub may allow a builder the option of tracking and modifying each component 205 that depends from the centralized code class 225 or instead, create new code classes 225 similar to the central code class 225 and in effect, create smaller hubs for build efficiency.

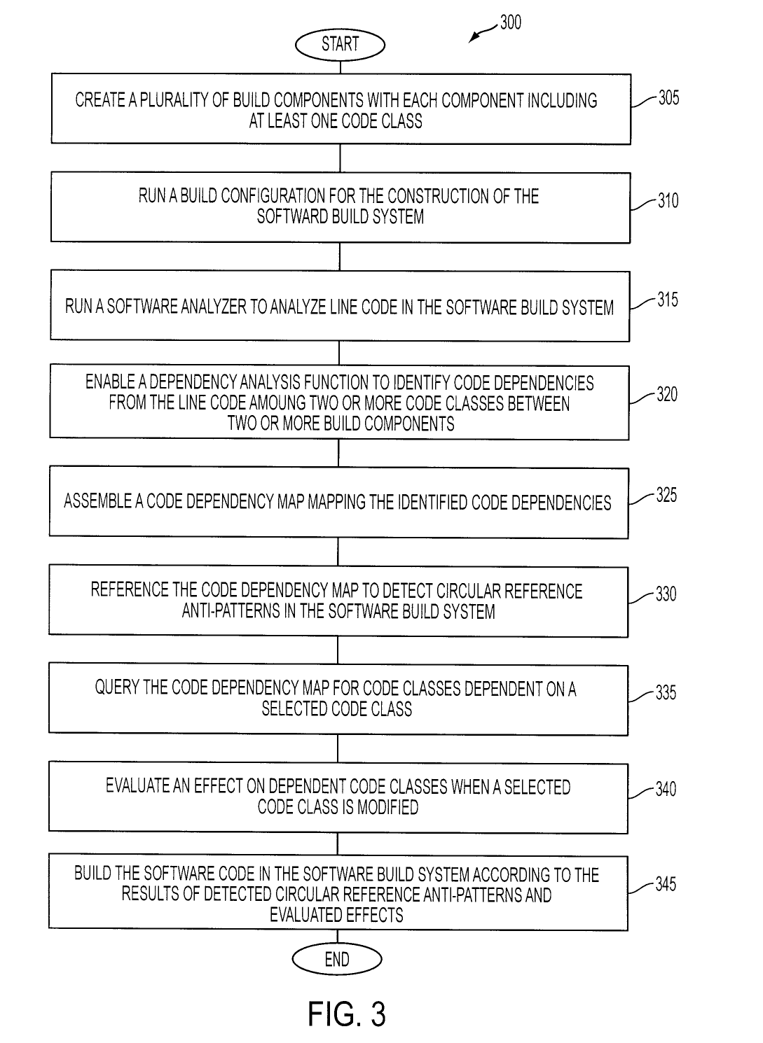

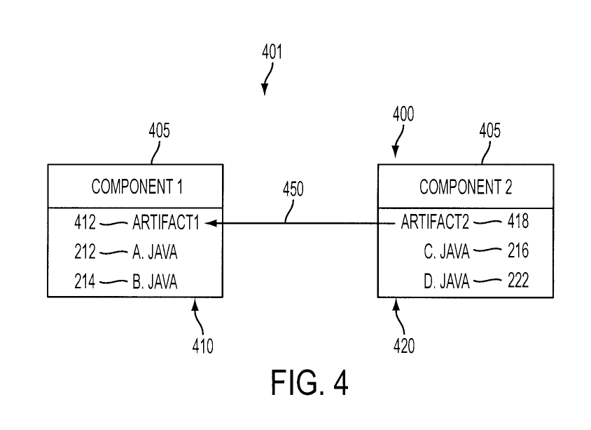

FIG. 3 illustrates a flow chart of an exemplary method 300 of constructing a software build system 130. In block 305, a plurality of build components 205 may be created with each component 205 including at least one code class 225. In block 310, a build configuration 135 can be run for the construction of the software build system 130. In block 315, a software analyzer 120 can be run for analyzing line code in the software build system 130. The software analyzer 120 may enable a dependency analysis function 125 to identify code dependencies 250 from the line code among two or more code classes 255 between two or more build components 205 (block 320). A code dependency map 201 may be assembled mapping the identified code dependencies in block 325. A builder may refer to the code dependency map 201 to detect circular reference anti-patterns in the software build system 130 in block 330. In block 335, the code dependency map 201 may be queried for code classes 225 dependent on a selected code class 225. A builder may then evaluate an effect on dependent code classes 225 when the selected code class 225 is modified in block 340. The software code in the software build system 130 may be built according to the results of detected circular reference anti-patterns and evaluated effects in block 345.

While the foregoing has been described in the context of dependencies 250 between code classes 225, it may be appreciated that, with reference to FIG. 4, an exemplary static structural analysis system 400 may illustrate a non-code dependency 450 using a dependency map 401. It will be understood that in some build configurations 135 (FIG. 1), components 405 may also include some non-code classes such as artifacts 412 and 418 that may be constructed outside the main software code 105 (FIG. 1). The embodiment shown in FIG. 4 is similar to the embodiment shown in FIG. 2 except that a component1 (410) and a component2 (420) include Artifact1 (412) and Artifact2 (418) respectively. For illustrative purposes only, Component1 (410) may also include code class 212 A.java and code class 214 B.java. Component2 (420) may also include code class 216 C.java and code class 222 D.java. Artifacts 412 and 418 may be data other than code classes 225. Some exemplary artifacts 412;418 may include, plug-in code or xml files that may be introduced from outside the main software code 105 for augmenting the build configuration 135. In this exemplary embodiment, artifact 418 may be dependent on artifact 412. Thus, the dependency map 401 may track such a dependency 450 allowing a builder to target and focus rebuilding of the build system 130 between components (410) and component2 (420) when artifact 412 may be modified. It will also be understood that similar to the system 200, the dependency map 401 may also be used to track undesirable dependencies such as circular dependencies, anti-reference patterns, etc.

It is to be understood that the specific embodiments of the invention that have been described are merely illustrative of certain applications of the principle of the present invention. Numerous modifications may be made to a system and method for automatically relating components of a storage area network in a volume container described herein without departing from the spirit and scope of the present invention.

What is claimed is:

1. A method of constructing a software build, comprising:
creating a plurality of build components for the software build, each component including at least one code class;
running a build manager for the construction of the software build;
assembling components and code classes into a baseline build configuration;
storing definition files of the components and code classes in a repository;
accessing the repository with a software analyzer including a dependency analysis program;
enabling the software analyzer for analyzing line code in the build configuration using the dependency analysis program;
identifying code dependencies from the line code among two or more code classes between two or more build components;
assembling a code dependency map of the identified code dependencies;
referring to the code dependency map to detect circular reference anti-patterns in the software build;
querying the code dependency map for code classes dependent on a selected code class;
evaluating an effect on dependent code classes when the selected code class is modified; and
modifying the build configuration according to the results of detected circular reference anti-patterns and evaluated effects.
